(19) United States
(12) Patent Application Publication
(10) Pub. No.: US 2022/0005469 A1
(43) Pub. Date: Jan. 6, 2022

(54) Providing Interactive Feedback, on a Spoken Announcement, for Vehicle Occupants

(71) Applicant: Bayerische Motoren Werke Aktiengesellschaft, Muenchen (DE)

(72) Inventors: Sebastian HERGETH, Muenchen (DE); Frederik NAUJOKS, Muenchen (DE)

(21) Appl. No.: 17/280,583

(22) PCT Filed: Sep. 4, 2019
(86) PCT No.: PCT/EP2019/073525

§ 371 Date: Mar. 26, 2021

(30) Foreign Application Priority Data
Sep. 27, 2018 (DE) 10 2018 216 621.8

(51) Int. Cl. G10L 15/22; B60R 16/037; G10L 15/24

(52) U.S. Cl. CPC G10L 15/22; G01C 21/3629; G10L 15/24; B60R 16/0373

(57) ABSTRACT

A method for providing interactive feedback for vehicle occupants includes outputting a spoken announcement to a vehicle occupant. An acoustic reaction sensing means detects whether the vehicle occupant has understood the spoken announcement. The announcement is repeated when it is detected that the vehicle occupant as not understood the spoken announcement.

### BACKGROUND AND SUMMARY OF THE INVENTION

The invention relates to a method for providing interactive feedback for vehicle occupants, to a control unit, to a speech output device and to a vehicle.

Many functionalities in a vehicle nowadays have the option of speech output that communicates advice and information to the driver by way of an announcement. Such advice and information are output for example by the navigation system, but warnings and traffic messages are also output through a spoken announcement. It may often be the case that the driver only partially perceives the spoken notification, or misses it due to background noise or entertainment. The system will not repeat this notification that is not perceived again without a request. Options up until now for having an announcement repeated are in some cases highly complicated and require attention from the driver, such that said driver may even be distracted from the road.

There are already approaches for simplifying the request for repetition. In some implementations, there is thus the option of requesting repetition for example of the navigation announcement by pressing a button on the steering wheel. DE102011084664A1 proposes to monitor the gaze direction of the driver during and shortly after a spoken announcement. If the driver looks at the display means of the navigation system shortly after the spoken announcement, then it may be assumed that the driver has not understood the announcement and the spoken announcement containing the navigation information should be repeated. However, there is still a need for improvement in terms of recognizing when a driver has not understood a spoken announcement and performing a repetition with little or no effort or distraction for the driver.

One object of this invention is therefore to provide a corresponding method and a corresponding device, in the case of both of which these disadvantages are overcome. This object is achieved according to the invention by the features of the independent patent claims. Advantageous refinements are the subject matter of the dependent claims.

What is proposed is a method for providing interactive feedback for vehicle occupants, wherein a spoken announcement is output to a vehicle occupant in a vehicle. Using acoustic response detection means present in the vehicle, it is detected whether the driver has understood the spoken announcement. If this is not the case, the spoken announcement is repeated. In this case, the driver is in particular designated as vehicle occupant, since he is generally intended to be addressed by the spoken announcement, for example navigation instruction, warning, etc. It is however also possible to address any other vehicle occupant, depending on the nature of the spoken announcement.

In order to detect whether the vehicle occupant has understood the spoken announcement, which represents an acoustic output, detection means that are already present in the vehicle, in particular microphones, may be used as acoustic response detection means. It is however also possible to use other detection means that are able to receive an acoustic expression by the vehicle occupant.

For processing purposes, the detected signals are preferably transmitted to a control unit that is designed to receive signals from acoustic response detection means on the basis of an output of a spoken announcement to a vehicle occupant, in particular a driver, in the vehicle. The control unit is designed to process the received signals such that it is possible to determine that the vehicle occupant has not understood the spoken announcement. If this is the case, the control unit may output a signal to the speech output device arranged in the vehicle, such that the spoken announcement is repeated.

Such a speech output device may belong to a navigation system that outputs direction information, warnings, etc., depending on the implementation. It may however also belong to an infotainment or entertainment system that acoustically outputs warnings, information or other communications and awaits an appropriate response from the vehicle occupant. The response may in this case range from just understanding the output information and possibly responding up to an expected answer.

In the absence of a response or answer, the system should respond accordingly. However, the response may also be intentionally omitted, meaning that repetition of the statement would annoy the vehicle occupant. In some situations, it may be the case that the vehicle occupant has however simply not understood the spoken announcement, even though he attempted to and wanted to understand it. In this case, as already mentioned, there are already systems that track a gaze direction of the vehicle occupant in order to identify whether the gaze moves in the direction of a visually perceptible information unit, for example a display. A conclusion is then drawn therefrom that the vehicle occupant has not or not completely understood the spoken announcement or information, and the spoken announcement is repeated.

According to the present invention, the identification that a vehicle occupant has not understood the spoken announcement is implemented by way of speech recognition. The response of the driver to a spoken announcement is recorded using acoustic response detection means that are already installed or additionally arranged in the vehicle, such as microphones, and is then evaluated by a computer unit or control unit. If the system establishes that the vehicle occupant, through an appropriate announcement, acoustically requests repetition of the notification, or expresses his lack of understanding via an appropriate announcement, the system repeats the notification. An acoustically expressed lack of understanding may be expressed by short statements such as “eh?”, “what?”, or announcements containing predefined keywords such as “please repeat”, etc. By virtue of the input channels, for example microphone, being activated or opened for speech recognition purposes after the spoken announcement has ended or shortly before this, it is possible to detect a request by the vehicle occupant, interpret it in the control unit and respond appropriately. If no response from the vehicle occupant is made within a predefined time period or time interval, for example within 2 to 5 seconds after the end of the spoken announcement, it may be assumed that the spoken announcement has been understood and the input channels for example of the microphone may be closed again. As an alternative or in addition, it is possible for example to detect a response or else a facial expression that implies understanding of the message, and thereupon to close the input channels again.

It may also additionally be detected, for example by way of visual response detection means, whether the vehicle occupant has understood a spoken announcement, and if this is not the case, the spoken announcement is repeated. Sensors, cameras etc. that are present in the vehicle may be used for this purpose, these being able to detect gestures and/or mimics by the vehicle occupant or vehicle occupants. In this case too, the signal is transmitted to a corresponding control unit for further processing.

The control unit may in principle be designed as a separate control unit, as a control unit integrated in an existing control unit, but also as a control unit integrated in the corresponding response detection means, provided that this is possible in the response detection means.

The method is advantageously executed as software containing program code for performing the method. The software in this case advantageously runs on one or more software-controlled devices, for example the control unit.

To perform the method in a vehicle, it is necessary for the vehicle to be equipped accordingly. At least one speech output device, as well as acoustic response detection means, and depending on the implementation also visual response detection means, are necessary. A control unit that is able to process the signals and output corresponding commands is likewise necessary.

Further features and advantages of the invention become apparent from the following description of exemplary embodiments of the invention, with reference to the FIGURES of the drawing, which shows features according to the invention, and from the claims. The individual features may each be implemented individually on their own or in multiple form in any desired combination in a variant of the invention.

Preferred embodiments of the invention are explained in more detail below with reference to the appended drawing.

### BRIEF DESCRIPTION OF THE DRAWING

FIG. 1 shows a schematic illustration of important components for performing the method in a vehicle according to one embodiment of the present invention.

### DETAILED DESCRIPTION OF THE DRAWING

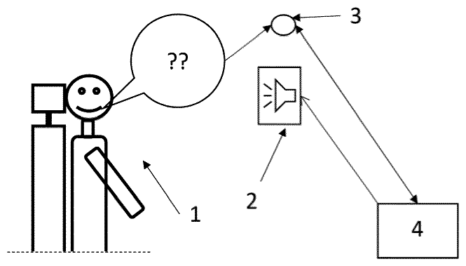

FIG. 1 shows a schematic view that explains both the most important components for performing the method, and the method. A speech output device is installed in the vehicle and serves to output a spoken announcement 2 to a vehicle occupant 1, for example the driver. If said driver has not understood the spoken announcement 2 and gives an appropriate acoustic response, which expresses the lack of understanding, as symbolized in FIG. 1 as a speech bubble containing “??”, this is detected by an acoustic response detection means 3, for example a microphone. The acoustic response detection means 3 is in this case preferably activated shortly before the end of or directly after the end of the spoken announcement 2. If an acoustic response has been detected, this is transmitted to a control unit 4 that is designed to process the acoustic signal and to interpret whether the vehicle occupant 1 has thus expressed his lack of understanding. If this is the case, the control unit 4 outputs a signal to the speech output device so that this repeats the spoken announcement 2. If the vehicle occupant 1 has again not understood the announcement, the method is repeated until no further acoustic expression of the lack of understanding is detected.

In order to improve the accuracy of the detection as to whether or not a vehicle occupant 1 has understood the spoken announcement 2, it is possible to use additional visual response detection means (not shown), as already mentioned. These may additionally detect mimics and/or gestures, and the control unit 4 may use this additional information to assess whether or not the vehicle occupant 1 has understood the spoken announcement 2 through his acoustic expression.

1-10. (canceled)

11. A method for providing interactive feedback for vehicle occupants, the method comprising:
outputting a spoken announcement to a vehicle occupant;
detecting, by way of an acoustic response detection means, whether the vehicle occupant has understood the spoken announcement; and
repeating the spoken announcement in response to detecting that the vehicle occupant has not understood the spoken announcement.

12. The method according to claim 11, wherein the detecting includes detecting at least one acoustically expressed lack of understanding by the vehicle occupant.

13. The method according to claim 11, further comprising:
detecting, by way of a visual response detection, whether the vehicle occupant has understood the spoken announcement.

14. The method according to claim 13, further comprising:
activating and maintaining as active for a predefined time the acoustic response detection means and the visual response detection means during or shortly before the end of the spoken announcement.

15. The method according to claim 14, wherein the predefined time is a fixed time interval or until detecting that the spoken announcement was understood.

16. A vehicle, comprising:
a speech output device configured to output spoken announcements an occupant of the vehicle;
an acoustic response detection means configured to detect a spoken response by a vehicle occupant; and
a control unit configured to:
receive signals from the acoustic response detection means, the signals corresponding to the spoken response;
determine from the signals whether the occupant has understood the spoken announcement; and
control the speech output device to repeat the spoken announcement, in response to determining that the occupant has not understood the spoken announcement.

17. The vehicle of claim 16, further comprising:
a visual response detection means configured to detect a visual response by the vehicle occupant,
wherein the control unit is further configured to:
receive additional signals from the visual response detection means, the additional signals corresponding to the visual response, and
determine from the additional signals whether the occupant has understood the spoken announcement.

18. A non-transitory processor readable medium having stored thereon software that, when executed by a computer, cause the processor to perform a method for providing interactive feedback for vehicle occupants, the method comprising:
causing a spoken announcement to be outputted to a vehicle occupant;
detecting, on the basis of signals received from an acoustic detection means in response to the output spoken announcement, whether the vehicle occupant has understood the spoken announcement; and
causing the spoken announcement to be repeated in response to detecting that the vehicle occupant has not understood the spoken announcement.
